(19) United States
(12) Patent Application Publication
(10) Pub. No.: US 2010/0243791 A1
(43) Pub. Date: Sep. 30, 2010

(54) GYROSCOPIC FAILURE DETECTION IN A NAVIGATION DEVICE THROUGH SENSOR CORRELATION

(75) Inventors: Zygmunt Zubkow, Palm Harbor, FL (US); Robert R. Bacon, Dunedin, FL (US)

Correspondence Address: HONEYWELL/FOGG;Patent Services, 101 Columbia Road, P.O Box 2245, Morristown, NJ, 07962-2245, US

(73) Assignee: Honeywell International Inc., Morristown, NJ (US)

(21) Appl. No.: 11/565,173

(22) Filed: Nov. 30, 2006

(51) Int. Cl. F42B 15/01; G06F 15/00; G01C 25/00; G05D 1/08; B64G 1/24

(52) U.S. Cl. 244/3.15; 702/183; 702/184; 244/177; 244/164

(57) ABSTRACT

A method of determining the integrity of a gyro in a navigation system is provided. The method includes detecting a relatively sudden change in one of a pitch, yaw and roll signal from a respective pitch, yaw and roll gyro and reviewing at least one other of the pitch, yaw and roll signals to verify the relatively sudden change.

### BACKGROUND

A common method of guiding a projectile such as a missile is with an inertial navigation system. A typical inertial navigation system uses data from gyros to provide roll pitch and yaw information. One issue that is of concern with inertial navigation systems is the ability to detect when a gyro is sending faulty data. Traditionally, errors as the result of faulty data from gyros are difficult to detect. As a result, a catastrophic failure in the navigation device could occur. One method used to detect gyro error incorporates another running redundant navigation system. The outputs of the primary navigation system and the redundant navigation system are then compared. In some cases, a third running navigation spare is used to break a tie in case the two navigation systems disagree.

For the reasons stated above and for other reasons stated below which will become apparent to those skilled in the art upon reading and understanding the present specification, there is a need in the art for an efficient and effective method of determining when a gyro is providing faulty data using a single system.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention. In one embodiment, a method of determining the integrity of a gyro in a navigation system is provided. The method includes detecting a relatively sudden change in one of a pitch, yaw and roll signal from a respective pitch, yaw and roll gyro and reviewing at least one other of the pitch, yaw and roll signals to verify the relatively sudden change.

### BRIEF DESCRIPTION OF THE DRAWINGS

The present invention can be more easily understood and further advantages and uses thereof more readily apparent, when considered in view of the detailed description and the following figures in which:

FIG. 1 is a block diagram of a device of one embodiment of the present invention;

FIGS. 2A and 2B is an illustration of coning;

FIG. 3 is a plot of gyro signals; and

FIG. 4 is a flow diagram of one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

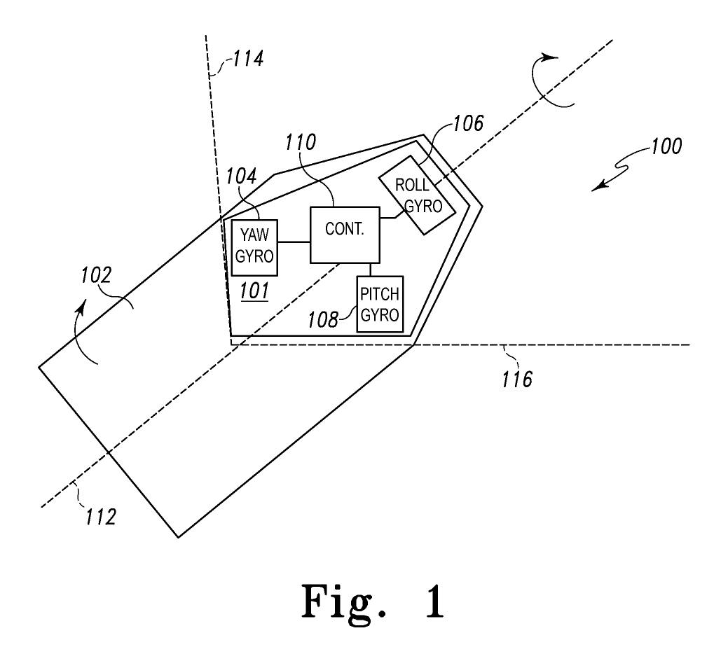

Embodiments of the present invention provide a method of determining when a gyro signal is faulty by evaluating one or more of the remaining gyro signals. Referring to FIG. 1, a device 100 with an inertial navigation system 101 of one embodiment of the present invention is provided. The device 100 may be missile such as an exoatmospheric ballistic missile or any type of flying device that requires navigation in a free coast environment. The device 100 includes a housing 100. Inside the housing 102 is the inertial navigation system 101. The inertial navigation system 100 includes a roll gyro 106, a pitch gyro 108 and a yaw gyro 104. The roll gyro 106 monitors the roll of device 100 about axis 112, the pitch gyro 108 monitors movement along axis 116 and the yaw gyro monitors movement along axis 114. Data signals from each of the gyros 104, 106 and 108 are processed by the controller 110. In response to the signals, the controller 110 directs functions that control the path of the device. As discussed above, if one of the gyros, 104, 106 and 108 provides a faulty signal, the controller could mistakenly direct the guidance of the device 100 in an improper manner. In embodiments of the present invention, the controller 110 monitors the signals from each gyro 104, 106 and 108 for sudden changes. If a relatively sudden change is detected in a signal, at least one of the other signals is reviewed to determine if a correlating change in that signal has also occurred. If a correlating change has not occurred, the controller has detected a faulty signal from the gyro. In one embodiment, that includes a redundant system, once a faulty gyro signal has been detected, a redundant gyro is used instead. In one embodiment of a redundant system two or more gyro would be represent by 104, 106 and 108 of FIG. 1.

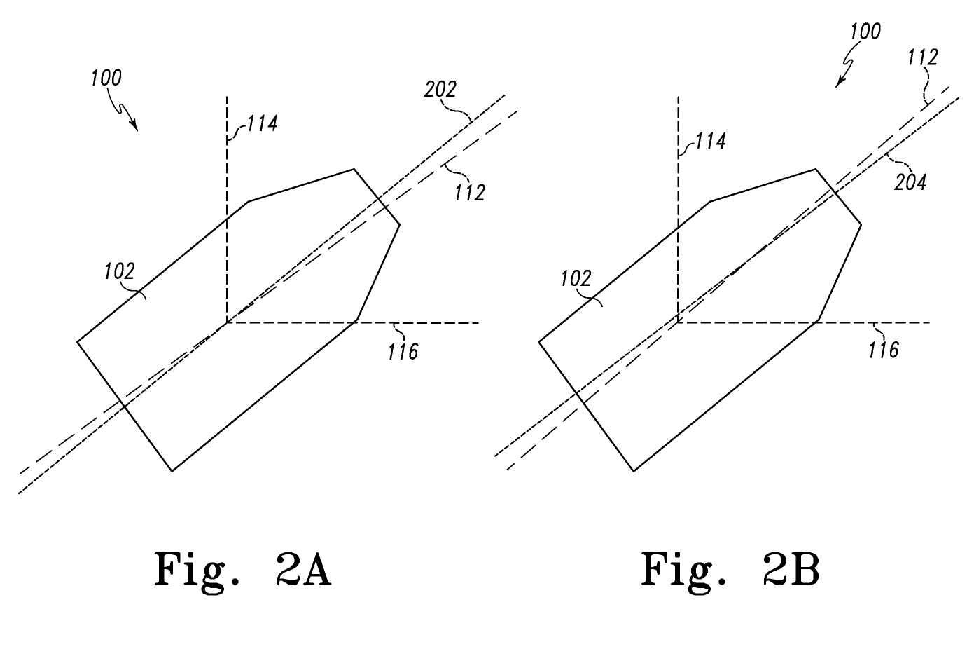

Embodiments of the present invention use signal relationships to determine if one or more gyro signals are bad. In the example of FIG. 1, the device rotates about roll axis 112. The roll axis 112 is the roll axis of flight. This roll motion detected by the roll gyro 106 produces a roll signal. Referring to FIGS. 2A and 2B signals generated by the pitch and yaw gyros are explained. FIG. 2A illustrates the device 100 were its rotation axis 202 is off in one direction from the intended axis of flight 112 at a moment of time. FIG. 2B illustrates the device 100 later in moment of time when its rotation axis 204 is off in another direction from the desired axis of flight 112. This wobbling off of the axis of flight 112 is called coning. The coning is read by the respective pitch and yaw gyros to produce respective pitch and yaw signals. Because the pitch and yaw axis 114 and 116 are 90 degrees apart, a phase relationship exists in the respective pitch and yaw signals generated from the pitch and yaw gyros 108 and 104.

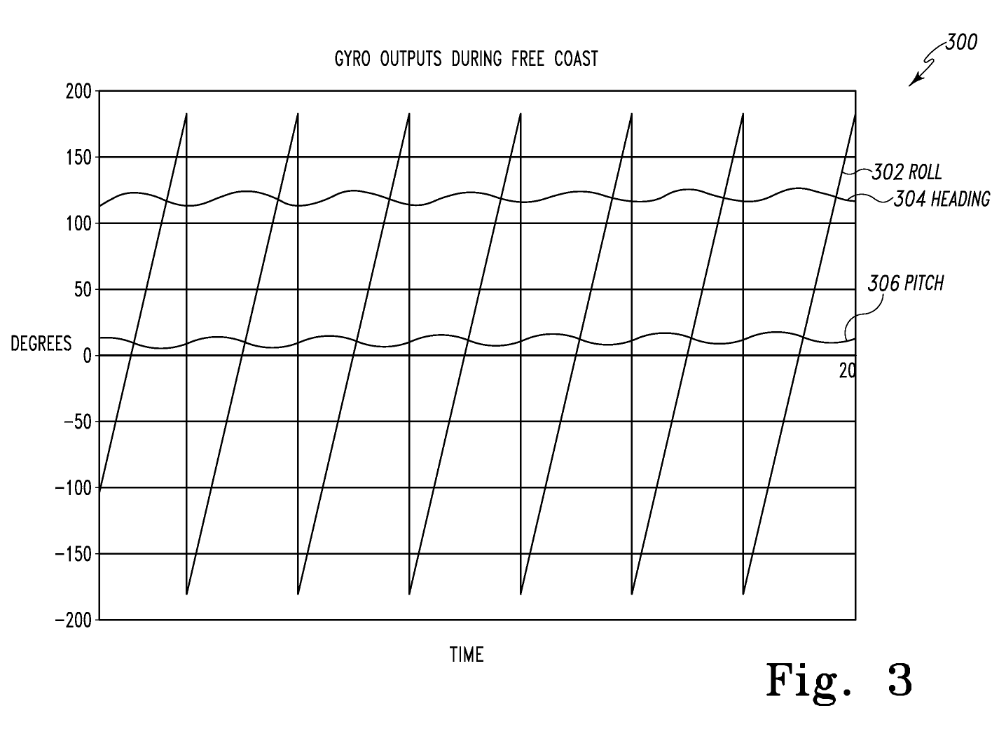

Gyro plot 300 of FIG. 3 illustrates the relationship between gyro signals 302, 304 and 306. As illustrated, the gyro signals 302, 304 and 306 are plotted with respect to degrees over time. As illustrated, the roll signal 302 is represented by a straight line having a constant slope that goes up and down between +180 degrees and −180 degrees. This roll signal in a plot over time would simply be a straight line having a constant slope. The yaw or heading signal 304 is a sinusoidal wave. The pitch signal is also a sinusoidal wave. The sinusoidal waves of the yaw and pitch signals are caused by the coning. Since the yaw and pitch axis' 114 and 116 are 90 degrees apart from each other, the yaw and pitch signals 304 and 306 will be 90 degrees out of phase with each other. Moreover, as illustrated in FIG. 3, they will have the same magnitude. This relationship information is used to determine if one of the signals is faulty.

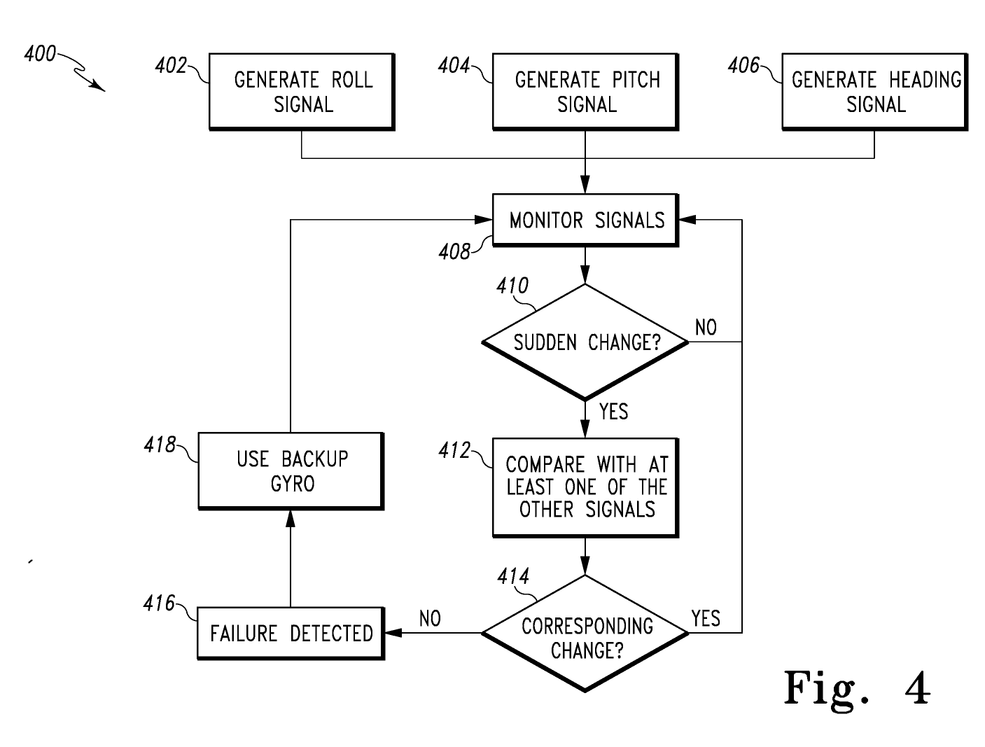

Referring to FIG. 4, a flow diagram 400 illustrating one method of operating a navigation system of the present invention is provided. As illustrated, roll signal, pitch signal and heading (or yaw) signals are generated from their respective gyros (402), (404) and (406). The signals are monitored (408). In one embodiment this is done by the controller 110. The signals are monitored for sudden changes (410). If no sudden change is detected (410), the signals are continued to be monitored at (408). If a sudden change occurs (410), at least one of the other signals are compared or reviewed (412). If there is a corresponding change in the at least one other signal (414), the signals are continued to be monitored at (408). If there is no corresponding change in the at least one other signal (414), a failure in an associated gyro signal has been detected (416). In one embodiment, once a failure of a gyro has been detected, the backup gyro is used in its place (418). After the replacement (418), the signals are again monitored at (408).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method of determining the integrity of a gyro in a navigation system, the method comprising:
detecting a sudden change in one of a pitch, yaw and roll signal from a respective pitch, yaw and roll gyro in the navigation system of a device experiencing coning in an exoatmospheric environment; and
reviewing at least one other of the pitch, yaw and roll signals to verify the sudden change.

2. The method of claim 1, further comprising:
monitoring the pitch signal from the pitch gyro in the navigation system;
monitoring the yaw signal from the yaw gyro in the navigation system; and
monitoring the roll signal from the roll gyro in the navigation system.

3. The method of claim 1, wherein verify the sudden change further comprises:
determining if a corresponding change occurred in the at least one other of the pitch, yaw and roll signals at the same time.

4. The method of claim 3, further comprising:
when a corresponding change is not observed, detecting a faulty gyro signal.

5. The method of claim 4, further comprising:
replacing the faulty gyro.

6. The method of claim 3, further comprising:
when a corresponding change is observed, verifying a valid gyro signal.

7. The method of claim 3, wherein the corresponding change is at least one of magnitude of signal change and frequency of signal change.

8. A method of navigation, the method comprising:
monitoring roll, pitch and yaw of a device experiencing coning in an free coast environment;
generating respective roll, pitch and yaw signals based on the monitoring of the roll, pitch and yaw of the device;
monitoring the roll, pitch and yaw signals for sudden changes; and
when a sudden change in one of the roll, pitch and yaw signals occurs in the monitored roll, pitch and yaw signals, verify if the signal with the sudden change is valid by verifying a corresponding change in at least one other of the roll, pitch and yaw signals.

9. The method of claim 8, further comprising:
when the roll, pitch and yaw signal with the sudden change cannot be verified, ignoring the signal.

10. The method of claim 8, further comprising:
replacing the roll, pitch and yaw signal with a respective backup signal when the respective roll, pitch and yaw signal with the sudden change cannot be verified.

11. The method of claim 8, wherein monitoring roll, pitch and yaw further comprises:
using respective roll, pitch and yaw gyros to monitor the respective roll, pitch and yaw.

12. The method of claim 8, wherein verifying a corresponding change in at least one other of the roll, pitch and yaw signals, further comprises:
detecting relative changes in at least one of magnitude and frequency at the same time as the signal with the sudden change.

13. The method of claim 8, wherein the device is an exoatmospheric device.

14. The method of claim 8, wherein the device is a missile.

15. A device having a navigation system, the device comprising:
a primary roll gyro configured to generate a roll signal based on the roll of the device;
a primary pitch gyro configured to generate a pitch signal based on the pitch of the device;
a primary yaw gyro configured to generate a yaw signal based on the yaw of the device; and
a controller adapted to control the navigation of the device based at least in part on the roll, pitch and yaw signals, the controller further configured to monitor each of the roll, pitch and yaw signals for sudden changes and to verify the accuracy of a roll, pitch and yaw signal with the sudden change by verifying a corresponding change in at least one other roll, pitch and yaw signal when the device is experiencing coning in an exoatmospheric environment.

16. The device of claim 15, further comprising:
a redundant roll gyro configured to generate a roll signal based on the roll of the device;
a redundant pitch gyro configured to generate a pitch signal based on the pitch of the device;
a redundant yaw gyro configured to generate a yaw signal based on the yaw of the device; and
wherein the controller is further configured to use a signal from a respective redundant roll, pitch and yaw gyro when the controller cannot verify the accuracy of the respective roll, pitch and yaw signal with the sudden change.

17. The device of claim 15, wherein verifying the corresponding change further comprises verifying at least one of the magnitude and the frequency of the at least one other roll, pitch and yaw signal.

18. The device of claim 15, wherein the device is a missile.

19. The device of claim 15, wherein the device is an exoatmospheric device.
